(19) United States
(12) Patent Application Publication
(10) Pub. No.: US 2014/0016152 A1
(43) Pub. Date: Jan. 16, 2014

(54) IMAGE PROCESSING APPARATUS AND METHOD AND NON-TRANSITORY COMPUTER READABLE MEDIUM

(71) Applicant: FUJI XEROX CO., LTD., Tokyo. (JP)

(72) Inventor: Miki ONITSUKA, Kanagawa (JP)

(73) Assignee: FUJI XEROX CO., LTD., Tokyo (JP)

(21) Appl. No.: 13/767,410

(22) Filed: Feb. 14, 2013

(30) Foreign Application Priority Data
Jul. 11, 2012 (JP) 2012-155422

(51) Int. Cl. H04N 1/21

(52) U.S. Cl. CPC H04N 1/21
USPC 358/1.13

(57) ABSTRACT

An image processing apparatus includes a receiver, a printer, and a sender. The receiver receives document data from a server via a network. The printer prints the received document data. The sender creates, in association with the document data, printing information used when the document data is printed, and sends the printing information associated with the document data to the server. The printing information is stored in the server in association with the document data.

### CROSS-REFERENCE TO RELATED APPLICATIONS

This application is based on and claims priority under 35 USC 119 from Japanese Patent Application No. 2012-155422 filed Jul. 11, 2012.

### BACKGROUND

(i) Technical Field

The present invention relates to an image processing apparatus and method and a non-transitory computer readable medium.

(ii) Related Art

With the recent development of cloud computing, image data including various documents used in an office are being more and more stored in a cloud server. A document stored in a cloud server is downloaded to a multifunction device and is printed when necessary. In this case, there may be a desire to print the same document again due to a request of additional printing, or a desire to print a document with the same printing format as a different document which has already been printed.

### SUMMARY

According to an aspect of the invention, there is provided an image processing apparatus including: a receiver that receives document data from a server via a network; a printer that prints the received document data; and a sender that creates, in association with the document data, printing information used when the document data is printed, and that sends the printing information associated with the document data to the server. The printing information is stored in the server in association with the document data.

### BRIEF DESCRIPTION OF THE DRAWINGS

Exemplary embodiments of the present invention will be described in detail based on the following figures, wherein:

FIG. 1 is a system diagram of an exemplary embodiment of the present invention;

FIG. 2 is a block diagram illustrating an example of the configuration of a multifunction device of an exemplary embodiment;

FIG. 3 illustrates a flow of a printing information file of an exemplary embodiment;

FIGS. 4 and 5 are flowcharts illustrating processing of an exemplary embodiment;

FIG. 6 illustrates display of an operation panel;

FIGS. 7 and 8 are flowcharts illustrating processing of another exemplary embodiment; and

FIG. 9 illustrates display of an operation panel.

### DETAILED DESCRIPTION

An exemplary embodiment of the present invention will be described below by taking the following multifunction device as an example of an image processing apparatus. The multifunction device downloads document data indicating documents, files, images, etc. from a cloud service (server computer) disposed on the Internet and performs printing, which is an example of image processing. However, the image processing apparatus of an exemplary embodiment of the present invention is not restricted to such a multifunction device, and is applicable to any terminal that is capable of printing document data indicating documents, files, images, etc. by utilizing a cloud service disposed on the Internet.

### Basic Configuration

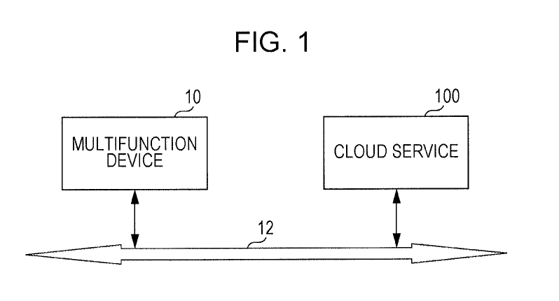

FIG. 1 is a system diagram of an exemplary embodiment of the present invention. A multifunction device 10, which serves as an image processing apparatus, is connected to a cloud service 100 via the Internet 12. In this exemplary embodiment, “cloud” means a computer group existing on the Internet, particularly, a server computer disposed on the Internet.

The multifunction device 10 has various functions, such as a function of scanning documents, a function of transferring image data obtained by performing scanning to a document management server disposed in the cloud service 100 via the Internet 12, a function of downloading image data from a document management server disposed in the cloud service 100, and a function of viewing/printing image data. In this exemplary embodiment, a description will be given of a series of processing operations for downloading a desired item of image data from a document management server disposed in the cloud service 100 and for printing the downloaded item of image data by using the multifunction device 10.

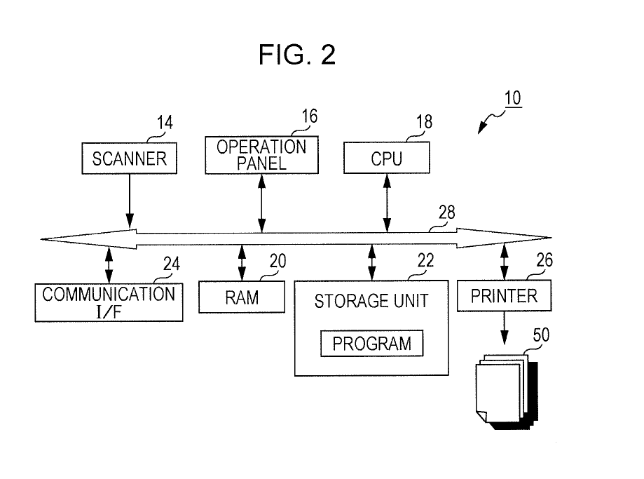

FIG. 2 is a block diagram illustrating the configuration of the multifunction device 10. The multifunction device 10 includes a scanner 14, an operation panel 16, a central processing unit (CPU) 18, a random access memory (RAM) 20, a storage unit 22, a communication interface (I/F) 24, a printer 26, and a bus 28. The multifunction device 10 includes the CPU 18, the RAM 20, and the storage unit 22, and implements various functions by reading and executing a program stored in the storage unit 22. Accordingly, the multifunction device 10 serves as a computer, particularly, a client computer.

The scanner 14 converts a document into image data by scanning the document, and then stores the image data in the RAM 22. The format of the image data is not particularly restricted, and may be a portable document format (PDF).

The operation panel 16 is used for setting various parameters by a user when scanning a document with the scanner 14, and for setting various settings by a user when transferring (uploading) image data obtained by performing scanning to the cloud service 100. The operation panel 16 is also used for setting various settings by a user when viewing/printing a document stored in the cloud service 100.

The storage unit 22 stores a processing program. The RAM 20 serves as a working memory and stores image data obtained by performing scanning and image data downloaded from the cloud service 100. The RAM 20 also temporarily stores a created printing information file, which will be discussed later.

The CPU 18 reads and executes the processing program stored in the storage unit 22, thereby controlling operations of the individual elements of the multifunction device 10 in accordance with the processing program. More specifically, the CPU 18 controls the operation of the scanner 14 in accordance with parameters set through the use of the operation panel 16 so that the scanner 14 may scan a document with the set parameters, and stores image data obtained by scanning the document in the RAM 20. In response to an instruction set through the use of the operation panel 16, the CPU 18 also accesses the cloud service 100 via the communication I/F 24 and transfers image data stored in the RAM 20 to a document management server disposed in the cloud service 100. Additionally, in response to an instruction set through the use of the operation panel 16, the CPU 18 also downloads image data stored in a document management server disposed in the cloud service 100 and displays the downloaded image data on the operation panel 16, thereby enabling a user to view the image data. The CPU 18 also supplies the downloaded image data to the printer 26 and causes the printer 26 to print the image data as a document 50. After printing the document 50, the CPU 18 automatically creates information concerning the printing of the document 50 as a printing information file and transfers the printing information file to a document management server disposed in the cloud service 100 via the communication I/F 24.

One of the features of this exemplary embodiment of the present invention is as follows. After downloading image data from a document management server disposed in the cloud service 100 and printing the image data, the CPU 18 of the multifunction device 10 automatically creates a printing information file and transfers it to a document management server disposed in the cloud service 100. The transferred printing information file is stored in the document management server disposed in the cloud service 100 in association with the image data. In this exemplary embodiment, “association”, “associating”, or “associated” means, not only that image data and a printing information file are linked to each other, but also that a certain item of data necessary for accessing one of the image data and the printing information file is attached to the other one of the printing information file and the image data. More specifically, a tag for a printing information file is attached to the associated item of image data, and a tag for an item of image data is attached to the associated printing information file.

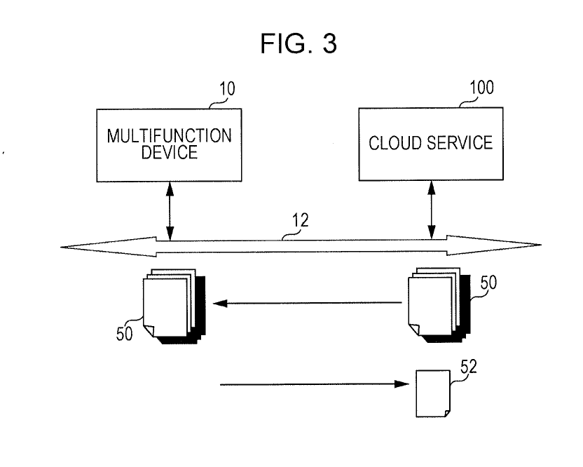

FIG. 3 schematically illustrates a series of operations for printing the document 50 performed by the multifunction device 10. The multifunction device 10 first accesses a document management server disposed in the cloud service 100 in response to a request from a user, and selects and downloads the document 50 from among various items of image data stored and managed by the document management server. Then, the multifunction device 10 prints the document 50 which has been downloaded in response to a request from the user by using the printer 26. When performing printing, the user sets printing conditions, such as the color, size, number of print copies, N-up printing (printing an N pages' content in one page), by using a setting menu provided by the multifunction device 10.

After printing the document 50, the multifunction device 10 automatically creates a printing information file 52 indicating information concerning the printing of the document 50, and transfers the created printing information file 52 to a document management server disposed in the cloud service 100. The document management server to which the printing information file 52 is transferred is desirably the same as a document management server storing the document 50. However, this is not always necessary. The printing information file 52 describes printing information concerning the document 50 and is stored in association with the document 50.

The printing information file 52 is associated with the document 50 as a separate file, for example, an Extensible Markup Language (XML) file. Alternatively, the printing information file 52 may be generated in the format of a tag for the document 50 and may be stored in a document management server. The printing information file 52 is created in a format which matches a format provided by the cloud service 100 and is transferred to a document management server disposed in the cloud service 100. The printing information file 52 is a file describing the attributes of the document 50 and may be considered as meta information.

In the printing information file 52, at least the following items of information concerning print jobs of the document 50 are described:

### (1) File Information

format, size, author, page, etc.;

### (2) Printing Log

printing time and date, user information, device information, number of printing operations, etc.; and

### (3) Printing Parameters

printing conditions, such as color/monochrome, size, N-up, etc.

The printing information file 52 is stored in a document management server disposed in the cloud service 100 such that it is associated with the document 50. Accordingly, when viewing/printing the document 50 by accessing the cloud service 100 by using the multifunction device 10 or another multifunction device, a user is able to view the printing information file 52 as well as the document 50. Thus, when printing the document 50 again by using the multifunction device 10 or another multifunction device, the user is able to recognize printing logs or printing parameters by referring to the printing information file 52, and to print the document 50 with printing conditions similar to those set for the previous printing operation if necessary. For example, after printing the document 50, if it becomes necessary to print one more copy of the document 50, the document 50 may be printed with exactly the same printing conditions as those of the previous printing operation.

Since the printing information file 52 is stored in a document management server of the cloud service 100, it does not have to be stored in a storage unit of the multifunction device 10 or a storage unit of, for example, a print server which is connected to the multifunction device 10 via a local area network (LAN). Additionally, the type of format of the printing information file 52 is not restricted. Accordingly, the printing information file 52 may be created in a desired format provided by the cloud service 100 and may be associated with the document 50 as meta information of the document 50. Thus, it is not necessary that the cloud service 100 have a function specially used for printing management. Moreover, if there is a desire to print the document 50 again, not only the multifunction device 10 which has printed the document 50, but also another multifunction device which can access the cloud service 100 is able to print the document 50 by utilizing the printing information file 52.

Printing processing performed in this exemplary embodiment will be described in a greater detail.

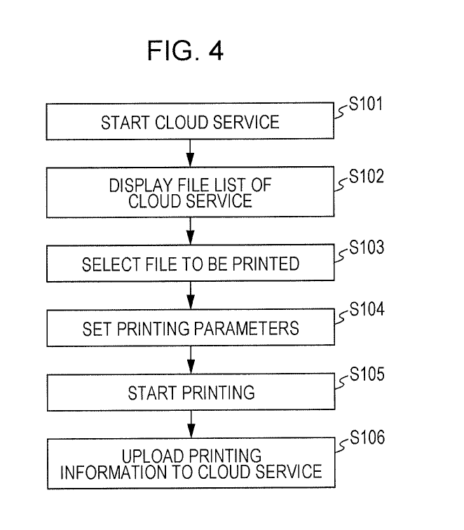

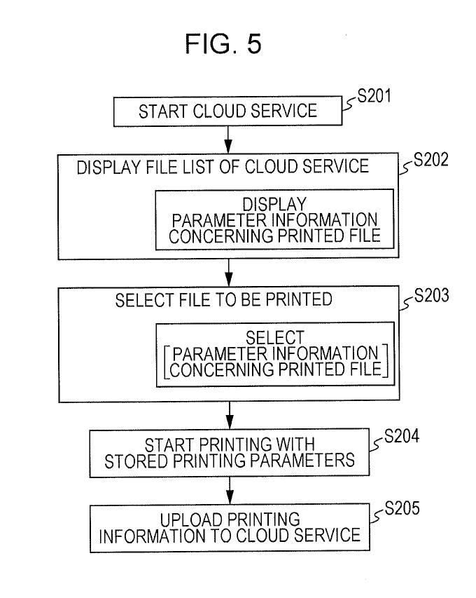

FIGS. 4 and 5 are flowcharts of processing performed in this exemplary embodiment, principally by the CPU 18 of the multifunction device 10. FIG. 4 illustrates processing for printing the document 50 for the first time, and FIG. 5 illustrates processing for printing the document 50 for the second or subsequent time. The following description will be given, assuming that image data is a file.

In FIG. 4, in step S101, the multifunction device 10 starts a cloud access service. More specifically, the CPU 18 accesses a document management server of the cloud service 100 via the communication I/F 24, and executes log-in processing (including user authentication performed by inputting a user ID and a password) necessary for utilizing document management services provided by the document management server.

Then, in step S102, the CPU 18 displays a file list of the cloud access service. More specifically, the CPU 18 downloads list data concerning a list of files stored in the document management server of the cloud service 100 and displays the list data on the operation panel 16.

In step S103, the user checks the file list displayed on the operation panel 16 of the multifunction device 10 and selects a file to be printed. In step S104, the user also sets printing conditions used for printing the selected file as printing parameters (print parameters) by operating the operation panel 16. As stated above, the printing conditions concern the color, size, N-up, etc., and the printing conditions set by the user are stored in the RAM 20. In step S105, the CPU 18 downloads the file selected by the user from the document management server disposed in the cloud service 100 and stores the file in the RAM 20. Then, the CPU 18 supplies the file to the printer 26, and the printer 26 prints the file in accordance with the printing parameters set by the user and stored in the RAM 20.

In step S106, after finishing printing the file in the printer 26, the CPU 18 creates a printing information file concerning the printed file and transfers (uploads) the printing information file to the document management server disposed in the cloud service 100 via the communication I/F 24. The printing information file includes file information, printing logs, and printing parameters of the printed file. The printing parameters are printing conditions stored in the RAM 20. The printing logs include the printing time and date, the user who has printed the file, the multifunction device 10 used for printing the file. As the information concerning the user, a user ID or a user name used for logging in the document management service provided by the cloud service 100 is used. As the information concerning the multifunction device 10, the ID or the IP address of the multifunction device 10 is used. The CPU 18 automatically creates the printing information file 52 and stores it in the RAM 20, and then transfers it to the cloud service 100. The printing information file 52 is created as, for example, an XML file, and is associated with a file to be printed. After transferring the printing information file 52 to the cloud service 100, the printing information file 52 does not have to be stored in the multifunction device 10, and thus, the CPU 18 deletes it from the RAM 20. The document management server disposed in the cloud service 100 stores the printing information file 52 transferred from the multifunction device 10.

In this manner, after printing a desired file, a printing information file associated with the printed file is automatically created and is stored in a document management server disposed in the cloud service 100. It is noted that the printing information file is not stored in the multifunction device 10 or in a print server.

In FIG. 5, in step S201, the multifunction device 10 or another multifunction device starts the cloud access service. In step S202, the CPU 18 displays a file list of the cloud access service on the operation panel 16. In this case, if there is a printing information file 52 associated with a file included in the file list displayed on the operation panel 16, the CPU 18 also displays such a printing information file 52 together with the associated file. This enables the user to recognize the fact that this file has been printed, since a printing information file 52 is automatically created after a file has been printed. In other words, the user is able to recognize the fact that a file for which a printing information file 52 is not displayed has not been printed.

For example, if A file, B file, and C file are displayed as a file list on the operation panel 16 and if a printing information file 52 is displayed together with the A file, the user is able to recognize that the A file has been printed and that the printing logs and printing parameters used when the A file was printed are stored. The user is also able to recognize that the B file and the C file have not been printed and that printing logs and printing parameters for the B file and the C file do not exist.

Then, in step S203, the user selects a file to be printed. In this case, if there is a printing information file 52 for the selected file, the user is able to select the printing information file 52 as well as the file. The CPU 18 downloads the selected file from the document management server disposed in the cloud service 100 and, if there is a printing information file associated with the selected file, the CPU 18 also downloads the printing information file 52. The CPU 18 then supplies the downloaded file to the printer 26, and also extracts printing parameters contained in the downloaded printing information file 52 and supplies the printing parameters to the printer 26. In step S204, the printer 26 prints the downloaded file by using the extracted printing parameters.

Conversely, even if there is a printing information file 52 for the selected file, the user may ignore such a printing information file 52. In this case, the user sets new printing conditions by using the operation panel 18 without using the printing parameters included in the printing information file 52 and prints the selected file.

In step S205, after finishing printing the file in the printer 26, as in step S106 of FIG. 4, the CPU 18 creates a printing information file 52 concerning the printed file and transfers (uploads) the printing information file 52 to the document management server disposed in the cloud service 100 via the communication I/F 24. If the printing information file 52 already exists for the printed file, the CPU 18 may overwrite or update the previous printing information file 52 instead of creating a new printing information file 52. For example, if the user has selected the printing information file 52 in step S203, it means that the printing information file 52 has already been downloaded from the document management server disposed in the cloud service 100 and stored in the RAM 20. Thus, the CPU 18 reads the printing information file 52 from the RAM 20 and updates printing logs included in the printing information file 52, thereby creating a new printing information file 52. If printing has been performed in step S204 with printing parameters different from those of the printing information file 52, the CPU 18 also updates the printing parameters, thereby creating a new printing information file 52. When overwriting and updating the printing information file 52, the CPU 18 may update the printing information file 52 by adding new information to the printing information file 52. After creating the new printing information file 52 and transferring it to the cloud service 100, the CPU 18 deletes the printing information file 52 from the RAM 20.

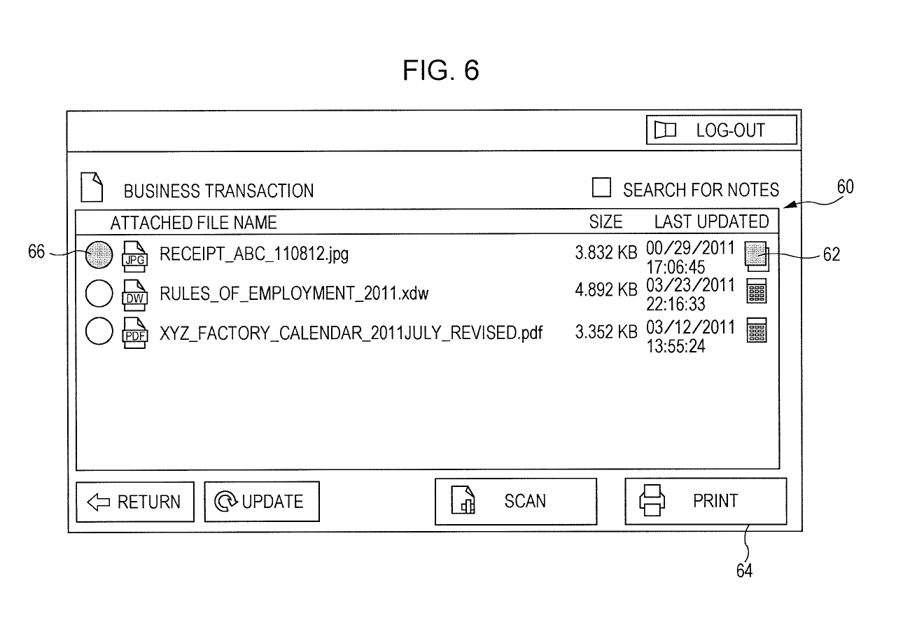

FIG. 6 illustrates an example of a screen displayed on the operation panel 16 as a result of performing the processing of step S202 of FIG. 5. On the operation panel 16, a file list 60 of files stored in a document management server of the cloud service 100 is displayed. These files are related to a user who has logged in the document management service of the cloud service 100, and three files are indicated as the file list 60 in FIG. 6.

Among the three displayed files, a specific icon 62 is shown on a file “receipt_ABC”. This icon 62 indicates the existence of a printing information file 52, and, more specifically, it indicates that there is a printing information file 52 associated with the file “receipt_ABC”. When a user operates the icon 62, the CPU 18 displays the printing information file 52 downloaded from the cloud service 100 on the operation panel 16, thereby enabling the user to view detailed information concerning the printing information file 52. A selection button 66 is shown at the head of each file name. When selecting a file, the user operates the selection button 66 of a desired file. FIG. 6 shows that the user has selected the file “receipt_ABC”. At the bottom of the screen, operation buttons for performing various operations are displayed, and when operating a “print” button 64, an instruction to print the selected file is sent to the CPU 18.

A specific procedure taken by using the operation panel 16 is as follows. The user selects a file to be printed from the file list 60 and operates the selection button 66. Then, the user operates the icon 62 to check details of the printing information file 52. The printing information file 52 includes printing parameters, and the user checks these printing parameters. The user then operates the print button 64 to give an instruction to print the selected file. The CPU 18 supplies the printing parameters included in the printing information file 52 to the printer 26, and the printer 26 performs printing in accordance with the printing parameters.

Alternatively, when the user operates the print button 64, the CPU 18 may display a message asking the user regarding whether to print the file in accordance with the printing parameters included in the printing information file 52. If the answer of the user is YES, the file is printed in accordance with the printing parameters. If the answer of the user is NO, the CPU 18 displays the printing parameters and allows the user to modify the printing parameters. For example, if the print size included in the printing parameters indicates A4 and the user wishes to print the file in B5, the user modifies the print size from A4 to B5. The CPU 18 supplies the modified printing parameters to the printer 26, and the printer 26 prints the file in accordance with the modified printing parameters.

In this exemplary embodiment, after printing a file, a printing information file 52 concerning the printing of the file is created and transferred to the cloud service 100. However, when storing a file in the cloud service 100, a printing information file 52 may be created by assuming a printing operation to be performed later and transferred to the cloud service 100 in advance.

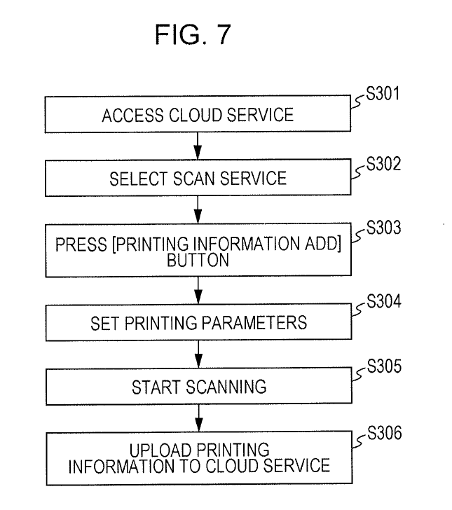

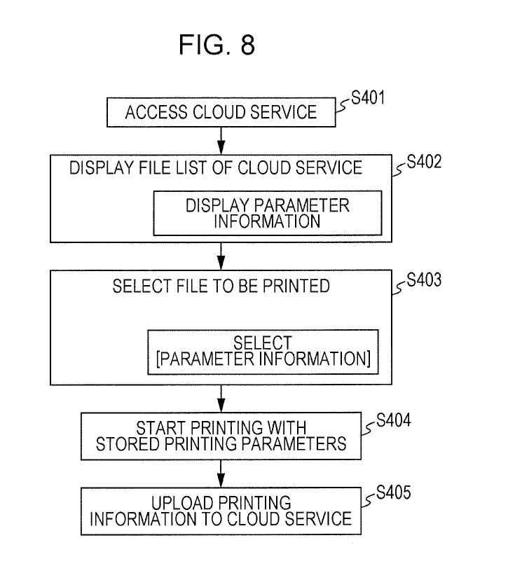

FIGS. 7 and 8 are flowcharts of processing of another exemplary embodiment when a printing information file 52 is transferred to the cloud service 100 before performing printing. FIG. 7 illustrates processing executed for the first time, and FIG. 8 illustrates processing executed for the second or subsequent time.

In FIG. 7, in step S301, the CPU 18 accesses a cloud access service. More specifically, the CPU 18 accesses a document management server disposed in the cloud service 100, and executes log-in processing necessary for utilizing document management services provided by the document management server.

Then, the CPU 18 selects a scan service on the operation panel 16 in step S302, and operates a printing information add button. The scan service may be selected by operating a “scan” button displayed at the bottom of the screen of the operation panel 16 shown in FIG. 6. The printing information add button is a button for storing, together with a scanned document, a printing information file 52 associated with the scanned document in the cloud service 100. In step S304, when the printing information add button is operated, a menu for setting printing conditions is displayed on the operation panel 16, and the user sets printing parameters by using this menu. The CPU 18 creates a printing information file 52 associated with a file of a document to be scanned by using the set printing parameters and stores the printing information file 52 in the RAM 20. Since the file has not been printed, the printing information file 52 does not include printing logs.

In step S305, after setting the printing parameters, when the user presses the scan button, the CPU 18 starts the scanner 14 and the scanner 14 scans the document and converts it to digital data. The CPU 18 then transfers the digital data to a document management server of the cloud service 100 via the communication I/F 24. In step S306, the CPU 18 also reads the printing information file 52 associated with the file obtained by scanning the document and transfers the printing information file 52 to the document management server of the cloud service 100. In this manner, uploading of the scanned document to the cloud service 100 and uploading of the printing information file 52 associated with the file of this document to the cloud service 100 has been completed.

In FIG. 8, in step S401, the CPU 18 accesses the cloud access service. Then, in step S402, the CPU 18 displays, on the operation panel 16, a file list of the cloud access service downloaded from the cloud service 100. In this case, if there is a printing information file 52 associated with a file included in the file list displayed on the operation panel 16, the CPU 18 also displays such a printing information file 52 together with the associated file. In step S403, the user selects a file to be printed, and also selects the printing information file 52 associated with this file. Then, in step S404, the CPU 18 downloads the selected file and the associated printing information file 52 from the cloud service 100 and supplies them to the printer 26. The printer 26 then prints the file in accordance with printing parameters extracted from the printing information file 52. In step S405, after printing, the CPU 18 creates a new printing information file 52 and transfers it to the cloud service 100.

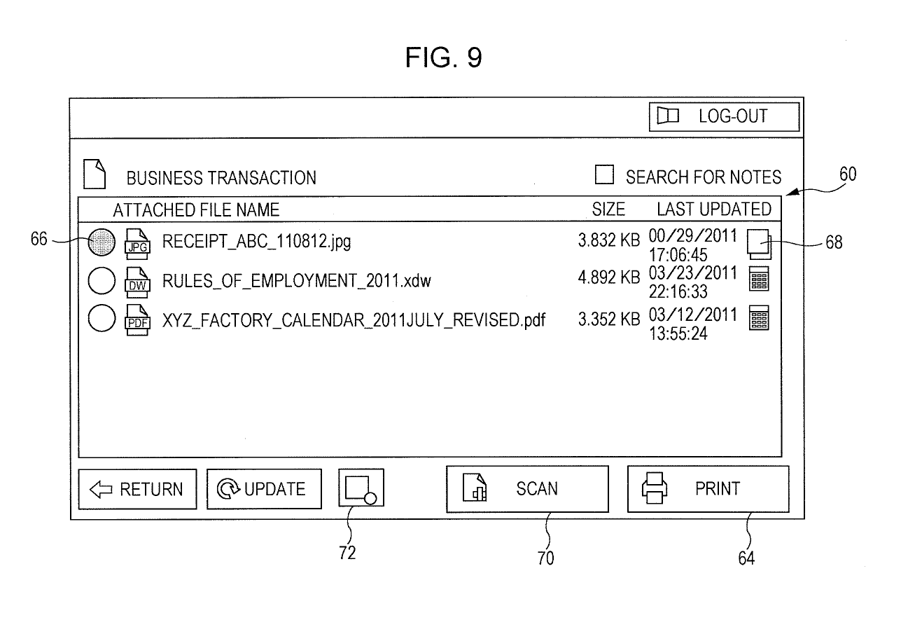

FIG. 9 illustrates an example of a screen displayed on the operation panel 16 as a result of executing the processing of step S402 of FIG. 8. On the operation panel 16, a file list 60 of files stored in a document management server of the cloud service 100 is displayed. These files are related to a user who has logged in the document management service of the cloud service 100, and three files are indicated as the file list 60 in FIG. 9. Among the three displayed files, an icon 68 is shown on a file “receipt_ABC”. The icon 68 indicates that there is a printing information file 52 associated with this file. Although this icon 68 indicates the existence of a printing information file 52, it is different from the icon 62 shown in FIG. 6. This is because the icon 62 indicates a printing information file 52 created after performing printing, while the icon 68 indicates a printing information file 52 created before performing printing. The icon 68 may be indicated in a color different from the icon 62, though the shape of the icon 68 is the same as that of the icon 62. When a user operates the icon 68, details of the printing information file 52 are displayed. That is, the print parameters set for the associated file to be scanned, transferred to and stored in the cloud service 100 are displayed. The user selects the file, checks the printing information file 52, and operates the print button 64. Then, the selected file and the printing parameters included in the printing information file 52 are supplied to the printer 26. The printer 26 then prints the file. In FIG. 9, a scan button 70 operated when performing scanning and a printing information add button 72 operated when creating a printing information file 52 are also shown.

As described above, in this exemplary embodiment, after printing image data or when scanning a document and transferring the resulting image data before performing printing, a printing information file 52 is created and is transferred to the cloud service 100 from the multifunction device 10. The printing information file 52 is stored in the cloud service 100 in association with the image data. Thus, it is not necessary to store printing information in the multifunction device 10 or in a print server. Additionally, since printing information is stored in the cloud service 100, when printing the associated image data, the multifunction device 10 or another multifunction device is able to easily access and obtain the printing information, thereby making it possible to print the image data with suitable conditions.

The exemplary embodiments of the present invention have been described above. However, the present invention is not restricted to these exemplary embodiments, and various modifications may be made.

For example, if the printing information file 52 is stored in a document management server disposed in the cloud service 100 by associating the printing information file 52 with image data as a tag, the printing information file 52 may be stored as a visualized tag which is visible on a web or as a hidden tag which is not visible on a web. That is, when the printing information file 52 is accessed from the multifunction device 10, the presence of the tag can be recognized, but when the printing information file 52 is accessed from, for example, a personal computer, the presence of the tag may be invisible.

Additionally, the handling of image data may be controlled by utilizing a printing information file 52. More specifically, if the printing logs of the printing information file 52 indicate that image data associated with the printing information file 52 has been printed, such image data may be deleted from a file list. This processing may be performed by the cloud service 100 or by the multifunction device 10. If the cloud service 100 performs this processing, before returning file list data to the multifunction device 10 in response to a request from the multifunction device 10, the cloud service 100 may refer to the printing information file 52 and remove files for which printing logs have been found from the file list. If the multifunction device 10 performs this processing, it may remove files for which printing logs have been found from the file list and display the file list on the operation panel 16.

Moreover, the multifunction device 10 may refer to printing logs included in a printing information file 52, and may set a display order of files in a file list in accordance with the printing logs. More specifically, the CPU 18 may arrange files in descending order of the number of printing operations indicated in the printing logs, and display the file list on the operation panel 16. A search may be conducted in the multifunction device 10 by using printing logs. For example, a user may specify a search condition “files without printing logs” by using the operation panel 16, and the CPU 18 may search for files without printing logs and display them on the operation panel 16.

In addition to file information, printing logs, and printing parameters, printing prohibit data may be included in the printing information file 52. As the printing prohibit data, certain conditions may be set, such as “printing is unconditionally prohibited”, “the maximum number of printing times is set”, and “a user allowed to perform printing is set”. If the printing information file 52 includes printing prohibit data, and when the icon 62 or 68 of a file associated with the printing information file 52 is operated, the CPU 18 may warn the user by displaying that the printing of the file is prohibited.

The cloud service 100 may perform specific processing by referring to a printing information file 52. For example, the cloud service 100 may refer to printing logs and remove a file for which printing has been performed by the multifunction device 10 or another multifunction device. Since the printing information file 52 includes, as printing logs, a user who has performed printing or a multifunction device which has performed printing, the cloud service 100 may be able to remove a file after a specific user or a specific multifunction device has printed the file.

In this exemplary embodiment, as shown in FIG. 5 or 8, when performing printing or scanning processing for the second or subsequent time, a new printing information file 52 may be created and transferred to the cloud service 100. Alternatively, if there is already a printing information file 52, processing may be terminated without creating a new printing information file. However, as stated above, if it is necessary to modify printing logs, it is desirable to create a new printing information file 52.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a receiver that receives document data from a server via a network;
a printer that prints the received document data; and
a sender that creates, in association with the document data, printing information used when the document data is printed, and that sends the printing information associated with the document data to the server,
wherein the printing information is stored in the server in association with the document data.

2. The image processing apparatus according to claim 1, further comprising:
a display that displays, if there is printing information stored in the server in association with document data, the existence of the printing information in association with the document data,
wherein the printer prints the document data on the basis of the printing information.

3. The image processing apparatus according to claim 2, wherein the printing information includes a printing condition or a printing log used when printing is performed by the printer.

4. The image processing apparatus according to claim 2, wherein the printing information includes data indicating that printing is prohibited, and the printer prohibits printing of document data associated with the printing information.

5. The image processing apparatus according to claim 2, wherein the printing information includes data indicating a maximum number of printing times, and if the number of times which document data associated with the printing information has been printed is equal to the maximum number of printing times indicated in the printing information, the printer prohibits printing of the document data.

6. The image processing apparatus according to claim 2, wherein the printing information includes data concerning a user allowed to print document data associated with the printing information, and the printer prohibits printing of the document data by a user other than the user allowed to print the document data.

7. The image processing apparatus according to claim 1, wherein the sender creates the printing information and sends the printing information to the server after the document data is printed.

8. The image processing apparatus according to claim 1, wherein the sender creates the printing information and sends the printing information to the server before the document data is printed.

9. An image processing method comprising:
receiving document data from a server via a network;
printing the received document data; and
creating, in association with the document data, printing information used when the document data is printed, and sending the printing information associated with the document data to the server.

10. A non-transitory computer readable medium storing a program causing a computer to execute a process, the process comprising:
receiving document data from a server via a network;
printing the received document data; and
creating, in association with the document data, printing information used when the document data is printed, and sending the printing information associated with the document data to the server.
